(19) United States
(12) Patent Application Publication
(10) Pub. No.: US 2026/0160552 A1
(43) Pub. Date: Jun. 11, 2026

(54) SURVEYING INSTRUMENT AND SURVEYING METHOD

(71) Applicant: TOPCON CORPORATION, Tokyo (JP)

(72) Inventor: Hajime KAWASAKI, Tokyo (JP)

(73) Assignee: TOPCON CORPORATION, Tokyo (JP)

(21) Appl. No.: 19/415,220

(22) Filed: Dec. 10, 2025

(30) Foreign Application Priority Data
Dec. 11, 2024 (JP) 2024-216547

(51) Int. Cl. G01C 15/00

(52) U.S. Cl. CPC G01C 15/006

(57) ABSTRACT

Provided is a surveying instrument which allows an operator to determine a direction in which the surveying instrument is installed even when the surveying instrument is invisible. The surveying instrument is configured to emit a visible laser beam coaxial with or parallel in a vertical plane to a sighting axis as main laser-pointer light; and emit a laser beam in a different form from the main laser-pointer light, as auxiliary laser-pointer light at a predetermined angle to the main laser-pointer light in a vertical plane containing the main laser-pointer light.

### TECHNICAL FIELD

The present disclosure relates to surveying instruments, and more particularly, to surveying instruments that emit visible laser beam along sighting axes thereof.

### BACKGROUND

Some conventional surveying instruments are configured to emit visible laser-pointer light that is coaxial with or parallel to the sighting axes to illuminate sighting points when an attempt is made to sight measurement targets using operation terminals for remote control. Such surveying instruments allow operators to make the surveying instruments sight desired target by controlling sighting directions of the surveying instruments while observing irradiated points of the laser-pointer light, the points which are to be collimation target.

### CITATION LIST

### Patent Literature

Patent Literature 1: JP 2015-125099 A

### SUMMARY OF INVENTION

### Technical Problem

However, when using an operation terminal for remote control instead of sighting through an eyepiece, operators cannot determine where a surveying instrument is installed only from an irradiated point of a laser pointer light without visually checking the surveying instrument. This makes it difficult to align the laser pointer beam with a desired point. Even though using a surveying instrument equipped with a camera, controlling a sighting direction to align with a desired point on an angled measurement surface, for example a ceiling, remains difficult. It is difficult to move the irradiated point of the laser pointer light in a desired direction via an operation terminal, even by looking at the camera image acquired from the surveying instrument or by looking at the actual irradiated point. This is because it is impossible to determine the sighting direction of the surveying instrument by a single irradiated point of the laser pointer light alone when the surveying instrument is not visible. Therefore, there has been a demand for determining the sighting direction of the surveying instrument even if the position of the surveying instrument is unidentifiable.

The technique of the present disclosure has been made in view of the above-mentioned problem, and the aim thereof is to provide a surveying instrument that allows operators to determine a direction in which the surveying instrument is installed even when the position of the surveying instrument is otherwise unidentifiable.

### Solution to Problem

To solve the above problem, a surveying instrument according to a first aspect of the present disclosure is configured to: emit a visible laser beam coaxial with or parallel in a vertical plane to a sighting axis as main laser-pointer light; and emit a laser beam in a different form from the main laser-pointer light, as auxiliary laser-pointer light at a predetermined angle to the main laser-pointer light in a vertical plane containing the main laser-pointer light.

According to this aspect, connecting two points, i.e. the irradiated points of the main laser-pointer light and auxiliary laser-pointer light indicates that the surveying instrument is positioned in the direction of extension of the line.

Further, a second aspect of the surveying instrument, in the first aspect, comprises a surveying instrument body, a telescope including an optical system provided in the surveying instrument body, and the telescope supported capable of rotating in a horizontal direction and vertical direction, a main laser pointer supported by the telescope and configured to irradiate the main laser-pointer light in a direction of an optical axis of the telescope, and an auxiliary laser pointer supported by the telescope and configured to irradiate the auxiliary laser-pointer light.

Further, a third aspect of the surveying instrument, in the first and second aspects, comprises the surveying instrument body, the telescope, a base portion, a rotary base rotatable with respect to the base portion, a cover member, the main laser pointer, and the auxiliary laser pointer, wherein the rotary base is provided with a supporting member that supports the telescope rotatably in a vertical direction, and the cover member covers the supporting member and the telescope, and wherein distance measuring light, the main laser-pointer light and the auxiliary laser-pointer light are transmitted through a window provided with the cover member. According to this aspect, the telescope is covered by the cover member and, thus, cannot be seen from the outside. Since the direction of the telescope represents the sighting direction, it is difficult to determine the sighting direction because the telescope is not visible. The irradiated points of the two laser pointers enable the operator to grasp the sighting direction.

Further, a fourth aspect of the surveying instrument, in the first to third aspects, the main lase-pointer light is visible distance-measuring-light. According to this aspect, a distance measuring light also serves as the main laser-pointer light, eliminating need to install a separate main laser pointer. This allows for a space-saving and simplified design of the surveying instrument.

Further, surveying method according to the present disclosure, using a surveying instrument configured to: emit a visible laser beam coaxial with or parallel in a vertical plane to a sighting axis as main laser-pointer light; and emit a laser beam in a different form from the main laser-pointer light, as auxiliary laser-pointer light at a predetermined angle to the main laser-pointer light La in a vertical plane containing the main laser-pointer light, and an operation terminal including an operation unit configured to operate a sighting direction of the surveying instrument, the method comprising: an irradiation step of irradiating the main laser-pointer light and the auxiliary laser-pointer light together, a determination step of determining the sighting direction of the surveying instrument based on an irradiated point of the main laser-pointer light and an irradiated point of the auxiliary laser-pointer light, an aligning step of aligning a horizontal direction of the operation terminal with the horizontal direction of the sighting direction of the surveying instrument, which determined in the determination step, a sighting step of bring the sighting direction of the surveying instrument to a desired direction via the operation terminal. According to this aspect, the sighting direction of the surveying instrument aligns with the direction of the operation terminal. Consequently, the direction of operation matches the direction of movement of the sighting point, enabling the operator to smoothly control the sighting direction.

### BRIEF DESCRIPTION OF DRAWINGS

Various aspects and embodiments of the application will be described with reference to the following figures. Items appearing in multiple figures are indicated by the same or a similar reference number in all the figures in which they appear.

FIG. 1 is a schematic perspective view illustrating an outline of a surveying instrument according to the present disclosure.

FIGS. 2A and 2B are schematic perspective views illustrating use states of the surveying instrument. FIG. 2A illustrates the surveying instrument sighting a floor, and FIG. 2B illustrates the surveying instrument sighting a ceiling.

FIG. 3 is a front view of the surveying instrument.

FIG. 4 is a schematic diagram illustrating internal structures of the surveying instrument.

FIG. 5 is a block diagram of the surveying instrument.

FIG. 6 is an optical block diagram of the surveying instrument.

FIGS. 7A and 7B illustrates examples of the surveying instrument. FIG. 7A is a perspective view of a survey site. FIG. 7B is a plan view of the survey site, viewed from above the ceiling. The surveying instrument is sighting the ceiling. The ceiling is shown as transparent as appropriate.

FIG. 8 is an explanatory diagram illustrating an effect of the surveying instrument and is a perspective view from an operator's side at the same survey site.

FIG. 9 is a comparative diagram illustrating the same survey site using a conventional surveying instrument, corresponding to FIG. 8.

FIGS. 10A and 10B illustrate examples of display screen of an operation terminal. FIG. 10A illustrates a display screen of the present configuration. FIG. 10B illustrates a display screen of the prior art for comparison.

FIG. 11 is an explanatory diagram illustrating the operation of the operator. FIG. 11 is a plan view of the survey site viewed from above the ceiling. The surveying instrument is sighting the ceiling. The ceiling is illustrated as transparent as appropriate.

FIG. 12 is a flowchart showing an example of using the surveying instrument.

### ADVANTAGES OF INVENTION

Above aspects can provide a surveying instrument that allows operators to determine the direction in which the surveying instrument is installed. The foregoing is a non-limiting summary of the invention, which is defined by the attached claims.

### DESCRIPTION OF EMBODIMENTS

Hereinafter, preferred embodiments of the present disclosure will be described with reference to the drawings. However, the present disclosure is not limited thereto. In each embodiment and each modification, the same constituents are denoted by the same reference signs, and redundant description will be omitted as appropriate.

### Outline of the Present Disclosure

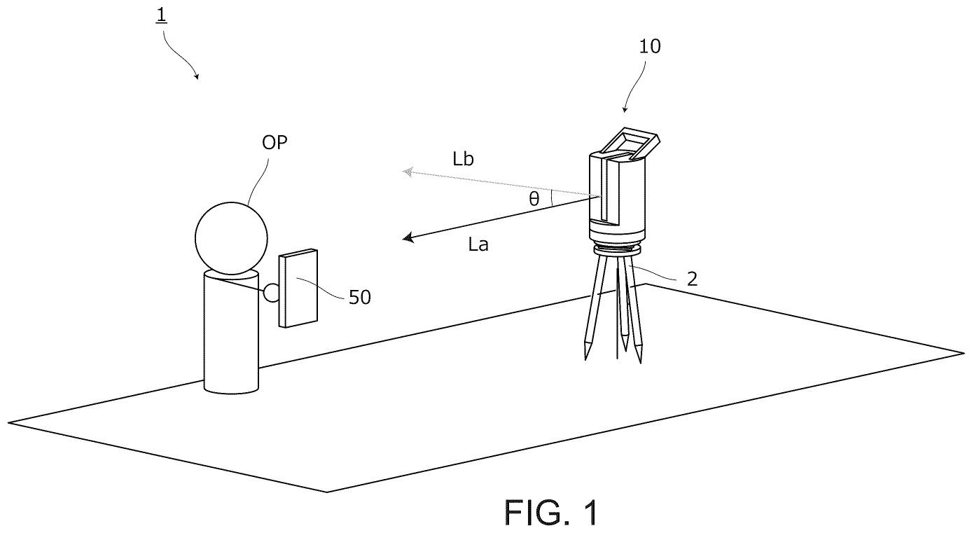

FIG. 1 is a schematic perspective view illustrating an outline of a surveying instrument 10 according to the present disclosure. The surveying instrument 10 is a total station equipped with a distance-and-angle measurement functions and a tracking function. The surveying instrument 10 can measure distance and angles using both non-prism and prism methods.

The surveying instrument 10 is configured to emit a main laser-pointer light La coaxially with or parallel in a vertical plane to a sighting axis. Furthermore, the surveying instrument 10 also emits an auxiliary laser-pointer light Lb at a predetermined angle to the main laser-pointer light La in a vertical plane containing the sighting axis, together with the main laser-pointer light La. Both the main laser-pointer light La and the auxiliary laser-pointer light Lb are visible light. An operator can determine a sighting direction of the surveying instrument 10 by observing irradiated points of the main laser-pointer light La and auxiliary laser pointer light Lb.

In this embodiment, the main laser-pointer light La is a visible red laser beam, and the auxiliary laser-pointer light Lb is a green laser beam. Furthermore, the main laser-pointer light La is emitted coaxially with the sighting axis, while the auxiliary laser-pointer light Lb is emitted, offset upward by a predetermined angle θ relative to the main laser-pointer light La in a vertical plane containing the sighting axis of the surveying instrument 10. Not limited to this, the auxiliary laser-pointer light Lb may be any visible laser beam of a different form from the main laser-pointer light La. For example, the auxiliary laser-pointer light Lb may be a laser beam having a different color from the main laser-pointer light La. Or, one may be flashing light whereas the other being continuous light. Or, one may have different flashing periods from the other. The main laser-pointer light may be implemented using a distance measuring light that is visible light. In this case, it is preferable for the main laser-pointer light La to be continuous light rather than flashing light. In addition, the auxiliary laser-pointer light Lb may be emitted offset downward by an angle θ relative to the main laser-pointer light La in the vertical plane containing the main laser-pointer light La.

The surveying instrument 10 is configured to be remotely controlled via an operation terminal 50. The operator OP can determine the sighting point and sighting direction of surveying instrument 10 from the irradiated points of main laser-pointer light La and auxiliary laser-pointer light Lb, even away from the surveying instrument 10. The operator OP can command the surveying instrument 10 to move the sighting direction to align the sighting point with an intended point, to measure distance and angle using the operation terminal 50 at hand, not only when near the surveying instrument 10 but also when away from the surveying instrument 10.

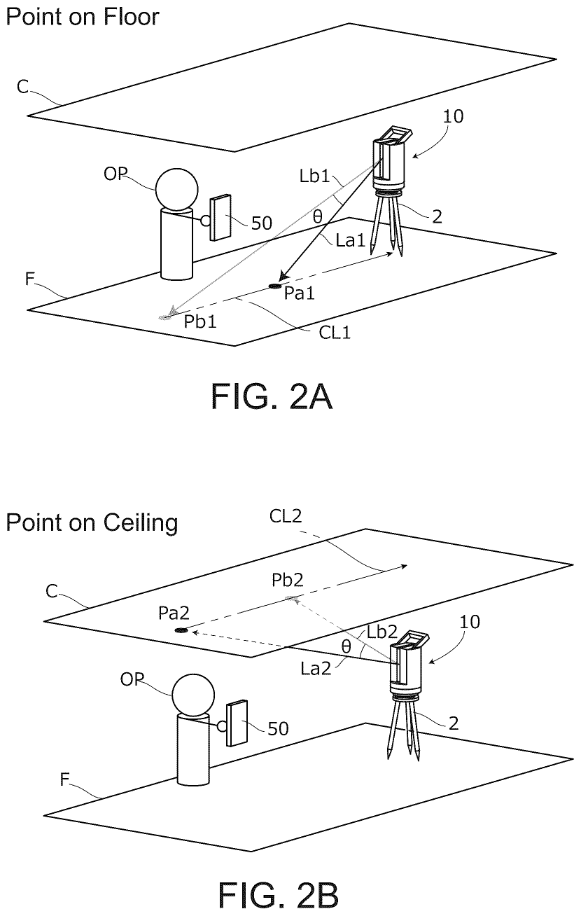

FIGS. 2A and 2B illustrate use states of the surveying instrument 10. FIG. 2A shows a green auxiliary irradiated-point Pb1 which is an irradiated point of the auxiliary laser-pointer light Lb1 on a floor F and a red main irradiated-point Pa1 which is an irradiated point of the main laser-pointer light La1 on the floor F, for example. The operator OP can determine the direction in which the surveying instrument 10 is installed by connecting the auxiliary irradiated point Pb1 and the main irradiated point Pa1 and extend a connecting line (see the chain-dotted line CL1). In addition, the operator OP can determine the sighting direction of the surveying instrument 10 from the arrangement of the two irradiated points.

Likewise, FIG. 2B shows a red main irradiated-point Pa2 which is an irradiated point of the main laser-pointer light La2 on a ceiling C and a green auxiliary irradiated-point Pb2 which is an irradiated point of the auxiliary laser-pointer light Lb2 on the ceiling C, for example. The operator OP can determine the direction in which the surveying instrument 10 is installed by connecting the auxiliary irradiated-point Pb2 and the main irradiated-point Pa2 and extend a connecting line (see the chain-dotted line CL2). In addition, the operator OP can determine the sighting direction of the surveying instrument 10 from the arrangement of the two irradiated points.

As illustrated in FIG. 2, the main laser-pointer light La and the auxiliary laser-pointer light Lb always form a V-shape at an angle θ centered on the optical center of the surveying instrument 10, rotating together in both the horizontal and vertical directions. Therefore, it should be noted that a connecting order of the irradiation points differs between the ceiling C and the floor F. When points to be measured are on the ceiling, the operator cannot set prisms at the points on the ceiling, and thus, cannot measure the points using prism method. The operator has to control the surveying instrument to align the sighting direction with each point on the ceiling. Operators often lose the direction in which the surveying instrument 10 is installed and the sighting direction of the surveying instrument 10 when the points are on the ceiling. In such cases, the operator has to manually guide the sighting direction to the measurement point. Accordingly, the surveying instrument 10 may be configured to emit the auxiliary laser pointer light Lb only when the sighting direction is horizontal or above. The surveying instrument 10 of this embodiment can rotate the sighting axis upward in the vertical direction by approximately 90 degrees. It should be noted that, when either of the two laser pointer lights rotates upward in the vertical direction by 90 degrees or more, the connecting order of the two irradiated points differs from that when the two laser pointer lights rotates upward in the vertical direction under 90 degrees.

Determining the direction in which the surveying instrument 10 is installed relative to the operator OP is useful for facilitating smooth operation when the operator OP remotely controls the surveying instrument 10 via the operation terminal 50 while the surveying instrument 10 is obscured by obstacles and invisible from the operator OP. Emitting not only the main laser-pointer light La but also the auxiliary laser-pointer light Lb enables operators OP to recognize not only the sighting point but also the direction in which the surveying instrument is installed and the sighting direction of the surveying instrument 10. Even when moving the sighting direction remotely using the operation terminal 50, the operator OP can determine the installation direction of the surveying instrument 10 from the two irradiated points, thereby enabling accurate operation.

Conventional surveying instrument has indicated only the sighting point with the laser-pointer light. It was difficult to operate the surveying instrument only using positional information of the irradiated point of laser pointer light, as an operator wishes. In particular, when the surveying instrument was invisible to the operator, the operator could know the sighting point but could not know the sighting direction. This makes it extremely difficult to remotely move the sighting point to a desired point.

By contrast, the surveying instrument 10 enables the operator OP to control the surveying instrument 10 to accurately move the sighting axis, even when the surveying instrument 10 is invisible, by determining the direction in which the surveying instrument 10 is installed and the sighting direction of the surveying instrument 10 from the main irradiated point Pa and auxiliary irradiated point Pb. The operator OP can move the main irradiated point Pa of the main laser-pointer light La, which is the sighting point, to a desired point and have the surveying instrument 10 to measure distance and angle of the sighting point.

### Surveying Instrument

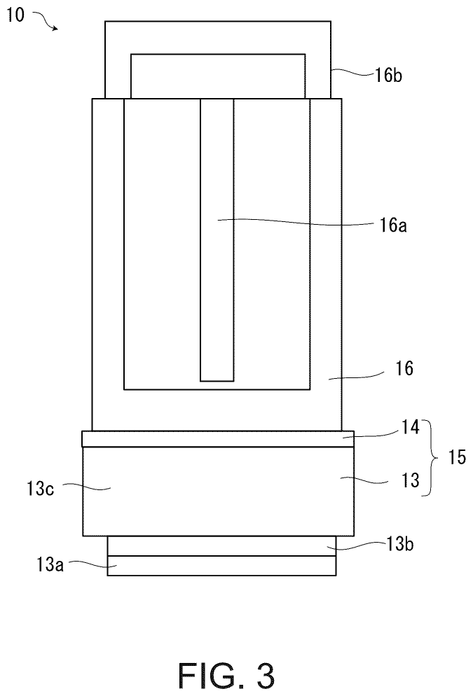

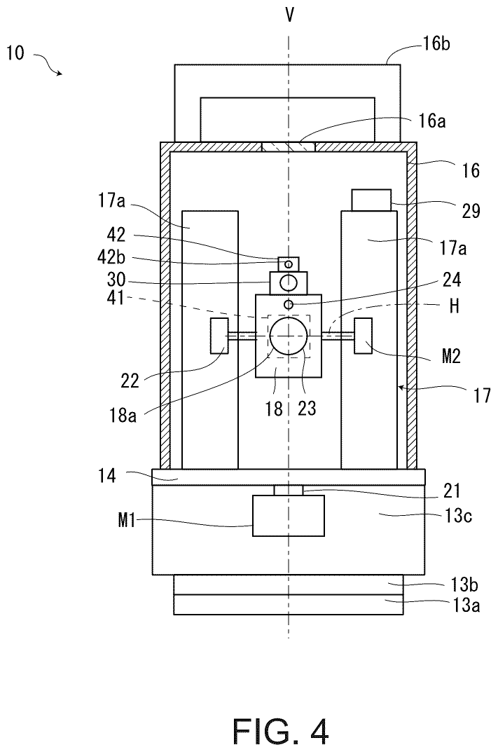

The surveying instrument 10 will be described with reference to FIGS. 3 and 4. FIG. 3 is a front view of the surveying instrument 10. FIG. 4 is a schematic diagram illustrating an internal structure of the surveying instrument 10.

The surveying instrument 10 comprises a base portion 13, a rotary base 14 configured to rotate horizontally relative to the base portion 13, a surveying-instrument body 15, and a cover member 16.

The base portion 13 primarily includes a fixed base 13a which is secured to the tripod base 2, a leveling base 13b which is equipped with leveling screws (not shown), and a case 13c which houses a drive mechanism including a horizontal rotation drive unit M1 which drives the rotary base 14 to rotate horizontally about the vertical axis V.

The rotary base 14 supports a bracket 17 which is composed of a pair of support members 17a and 17a, erect thereon. The support members 17a and 17b support a telescope 18 therebetween. The telescope 18 includes a measurement optical system and a tracking optical system.

The telescope 18 is configured to vertically rotate about a horizontal shaft H provided with the bracket 17. The telescope 18 has a main lens 18a, and the main lens 18a has an optical axis serving as the sighting axis of the surveying instrument 10. The telescope 18 houses a tracking unit 23, a distance measuring unit 24 and a main laser pointer 41 which emits the main laser-pointer light La. The bracket 17 includes a surveying-instrument control unit 29 on an upper surface.

The horizontal shaft H has a vertical rotation drive unit M2, which vertically rotates the telescope 18, at one end. The horizontal shaft H has a vertical angle detector 22, which detects a rotation angle of the telescope, at the other end.

The cover member 16 has a handle 16b on its top surface and a window 16a on its front surface. The window 16a extends vertically at the center of the front surface of cover member 16 and further extends continuously from the upper edge of the front surface to near the rear edge of the top surface across both the front and top surfaces (see FIG. 1). The handle 16b on the top surface is inclined rearward to avoid interference with window 16a (see FIG. 1). The window 16a is on the optical axis of the telescope 18 and transmits infrared laser light from the measurement optical system and tracking optical system described later, as well as the main laser-pointer light La and the auxiliary laser-pointer light Lb. Imaging of a scene in the sighting direction, described later, is performed through window 16a.

The telescope 18 has an imaging unit 30 at the top thereof. The sighting axis of the surveying instrument 10 and light-receiving direction of the imaging unit 30 are parallel in a vertical plane.

The telescope 18 has an auxiliary laser pointer 42 upper side of the imaging unit 30. The auxiliary laser pointer 42 emits auxiliary laser-pointer light Lb. The auxiliary laser pointer 42 includes a lens 42b. The lens 42b has an optical axis serving as an emission axis of the auxiliary laser pointer light Lb. The lens 42b of the auxiliary laser pointer 42 is directly above the main lens 18a of the telescope 18, and its optical axis is set upward at an angle θ relative to the optical axis of the main lens 18a of the telescope 18. The auxiliary laser pointer 42 may be mounted within the telescope 18 to emit the auxiliary laser-pointer light Lb via the main lens 18a.

### Block Diagram

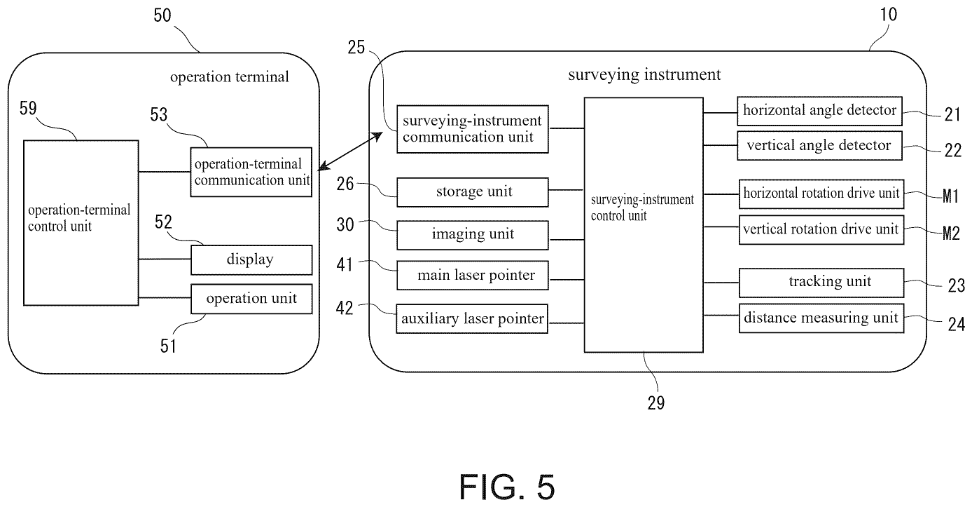

FIG. 5 is a control block diagram of the surveying instrument 10 and the operation terminal 50. The surveying instrument 10 comprises a horizontal angle detector 21, a vertical angle detector 22, the horizontal rotation drive unit M1, the vertical rotation drive unit M2, the tracking unit 23, the distance measuring unit 24, the surveying-instrument communication unit 25, a storage unit 26, the imaging unit 30, the main laser pointer 41, and the auxiliary laser pointer 42, and the surveying-instrument control unit 29 to which all these are connected.

The horizontal angle detector 21 and vertical angle detector 22 are implemented using rotary encoders, such as absolute encoders or incremental encoders. Such rotary encoders include a rotating disc, a slit, a light-emitting diode, and an image sensor. The horizontal angle detector 21 is mounted on the rotation shaft of the rotary base 14 and detects the horizontal angle of the rotary base 14. The vertical angle detector 22 is mounted on the horizontal shaft H of the telescope 18 and detects the vertical angle of the telescope 18.

The horizontal rotation drive unit M1 and the vertical rotation drive unit M2 are implemented using motors. Controlled by the surveying-instrument control unit 29, the horizontal rotation drive unit M1 drives the rotation shaft of the rotary base 14, while the vertical rotation drive unit M2 drives the horizontal shaft H of the telescope 18. The cooperative operation of both drive units changes the orientation of the telescope 18. The horizontal angle detector 21 and the vertical angle detector 22 constitute an angle measurement unit. The horizontal rotation drive unit M1 and the vertical rotation drive unit M2 constitute a drive unit.

The tracking unit 23 includes a tracking light emitting system which emits tracking light, such as infrared laser light having a different wavelength from the measurement light, and a tracking light receiving system implemented using an image sensor, such as a CCD sensor or CMOS sensor. The tracking unit 23 acquires a landscape image containing the tracking light and a landscape image excluding the tracking light, and sends both images to the surveying-instrument control unit 29. The surveying-instrument control unit 29 determines the center of the target image (prism) from the difference between the two images, detects the center as the target position, and automatically tracks the target to orient the telescope 18 always toward the target by ensuring the distance between the center of the target image and the optical axis center of the telescope 18 remains within a predetermined value range.

The distance measuring unit 24 includes a light emitter and a light receiver. The distance measuring unit 24 collimates at the distance measurement target, emits a distance measurement light toward the target, receives the reflected light with the light receiver, to measure the distance based on the phases of the distance measurement light and an internal reference light.

The surveying-instrument communication unit 25 enables communication with external networks. For example, the surveying-instrument communication unit 25 connects to the Internet using the Internet Protocol (TCP/IP) and exchanges information with the operation terminal 50. Wireless communication is not limited to this method; other known wireless communication methods may be used.

The storage unit 26 is implemented using a non-transitory computer readable storage medium, such as a hard disk drive, in which programs for arithmetic control are stored. The storage unit 26 also store acquired measurement data and status data.

The imaging unit 30 includes an imaging element, such as a CCD or CMOS, capable of acquiring real-time video. The imaging unit 30 in this embodiment is implemented using a so-called wide-angle camera, which has a wide field of view. The imaging unit 30 is provided above the telescope 18 such that their optical axes align horizontally, capturing the scene in front of the telescope 18. The imaging unit 30 sends the captured image of the scene to the operation terminal 50 via the surveying-instrument communication unit 25, so that the operation terminal 50 displays the image on the display 52. The imaging unit 30 may be placed within the telescope 18 such that the optical axis of the imaging unit 30 aligns with the sighting axis, and the center of the imaging unit 30 becomes the sighting axis.

The surveying instrument 10 allows for one-person operation. Even when away from the surveying instrument 10, an operator OP can observe the scene in front of surveying instrument 10 in real time by images captured by the imaging unit 30. In this embodiment, the surveying instrument 10 emits the main laser-pointer light La of visible light in the sighting direction. The imaging unit 30 captures the main irradiated point Pa of the main laser-pointer light La as the sighting point together with the scene in front of the telescope 18. The operator OP remotely controls the surveying instrument 10 via the operation unit 51 while observing the main irradiated point Pa on the display 52.

The main laser pointer 41 emits the main laser-pointer light La. The auxiliary laser pointer 42 irradiates the auxiliary laser-pointer light Lb.

The surveying-instrument control unit 29 is implemented using a microcontroller that a CPU, ROM, RAM, etc. are integrated into an integrated circuit, for example. The surveying-instrument control unit 29 connects to all components of the surveying instrument 10 to control to perform various function of the surveying instrument 10. Such functions include: driving of the horizontal rotation drive unit M1 and vertical rotation drive unit M2; light emission control of the tracking unit 23 and the distance measurement unit 24; automatic tracking of a measurement target; automatic sighting; distance and angle measurement; light emission control of the main laser pointer 41 and auxiliary laser pointer 42; and transmission of measurement data and commands via the surveying-instrument communication unit 25.

The operation terminal 50 includes an operation unit 51 for inputting commands, a display 52 which displays status and information, an operation-terminal communication unit 53 which transmits and receives commands to and from the surveying instrument 10, and an operation-terminal control unit 59 for controlling these components

The surveying instrument 10 and the operation terminal 50 connects to each other to communicate therebetween, particularly, to transmit and receive commands input to the operation terminal 50 and data acquired by the surveying instrument 10, via the surveying-instrument communication unit 25 and the operation-terminal communication unit 53.

The operation terminal 50 is not limited to a dedicated terminal device for the surveying instrument 10. For example, the operation terminal 50 may be implemented using smartphone or tablet which functions as a controller of the surveying instrument 10 are implemented by installing an application. Operators OP carry the operation terminals 50 to input commands as needed while monitoring the situation during surveying.

### Optical Block Diagram

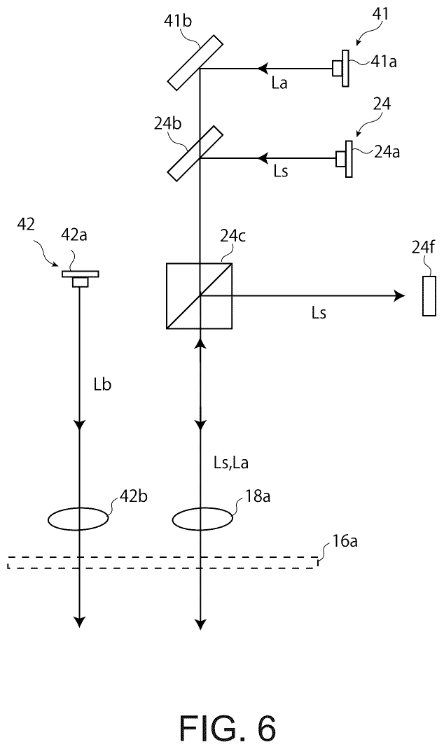

FIG. 6 is an optical block diagram of the surveying instrument 10. The distance measuring unit 24 comprises a distance-measuring-light emitter 24a, a distance-measuring-light transmission optical system 24b, a beam splitter 24c, and a distance-measuring light receiver 24f. The distance-measuring-light emitter 24a is implemented using a light emitting element, such as a semiconductor laser, and the distance-measuring-light receiver 24f is implemented using a light receiving element, such as an avalanche photodiode.

The distance measuring light Ls emitted from the distance-measuring-light emitter 24a passes through the distance-measuring-light emitting optical system 24b and the beam splitter 24c, then passes through the main lens 18a and window 16a of the telescope 18, to be output to the measurement target. The distance-measuring-light retroreflected by the measurement target enters the distance-measuring light receiver 24f via the beam splitter 24c. The distance measuring unit 24 measures the distance to the measurement target, based on time difference between an emission timing of the light-emitting element and a reception timing of the light-receiving element, that is, time of flight of the pulse, for each pulse.

The main laser pointer 41 includes a main-laser-light transmitter 41a and a main-laser-light transmission optical system 41b. The main-laser-light transmitter 41a is implemented using a light emitting element which emits a visible laser beam. The main-laser-light transmission optical system 41b guides the main laser-pointer light La emitted from the main-laser-light transmitter 41a onto the optical axis of the main lens 18a. The main laser pointer light La, then, passes through the main lens 18a and the window 16a to be output along the optical axis of the telescope 18.

The auxiliary laser pointer 42 includes an auxiliary-laser-light transmitter 42a and a lens 42b. The auxiliary-laser-light transmitter 42a is implemented using a light emitting element that emits a visible laser beam having a wavelength different from that of the main laser pointer light La. In other words, the auxiliary laser-pointer light Lb has a different emission color from the main laser-pointer light La. The auxiliary laser-pointer light Lb emitted from the auxiliary-laser-light transmitter 42a is collimated by the lens 42b and pass through the window 16a to be output. The auxiliary laser pointer 42 may be arranged within the telescope 18 such that the auxiliary laser-pointer light Lb is also output through the main lens 18a of the telescope 18.

### Example of Operation A specific example of surveying utilizing the surveying instrument 10 and the

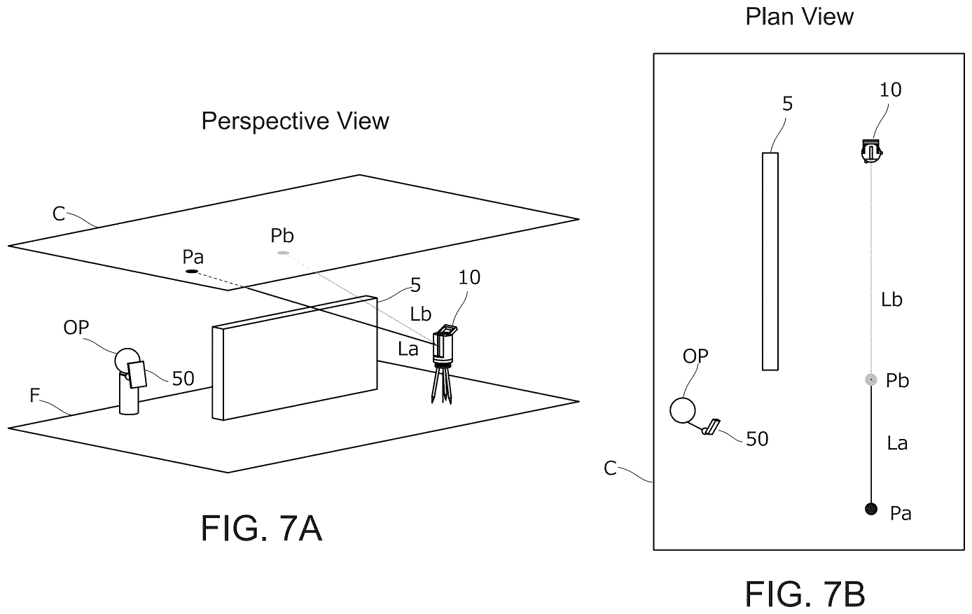

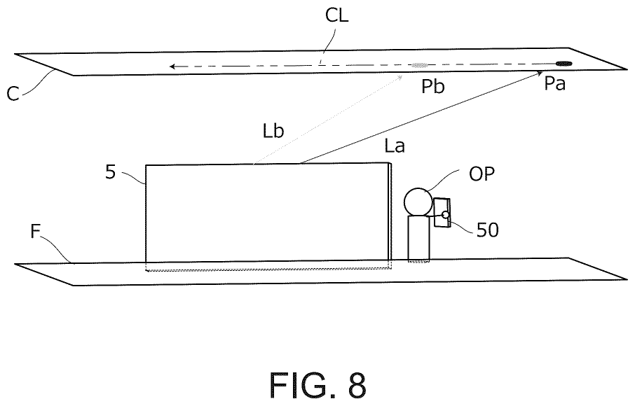

operation terminal 50 is described in detail with reference to the Drawings. FIGS. 7A and 7B illustrates an example of survey site, which is a store with a shelf 5 and a ceiling C. The ceiling C is an object to be surveyed. The survey site is partially illustrated transparently as appropriate. FIG. 7A is a perspective view of the survey site. FIG. 7B is a plan view of the survey site. FIG. 7B illustrates the survey site viewed from a position further above the ceiling C. The laser pointer lights La, Lb are projected onto the ceiling C. The ceiling C is shown as transparent. FIG. 8 illustrates the same survey site as viewed from the operator's side.

As illustrated in FIGS. 7 and 8, the surveying instrument 10 orients the sighting direction toward an elevation angle above horizontal. In this case, the surveying instrument 10 irradiates the main laser pointer light La on the ceiling C and the irradiated point is represented as the main irradiated point Pa. The surveying instrument 10 also irradiates the auxiliary laser-pointer light Lb on the ceiling and its irradiated point is represented as the auxiliary irradiated point Pb. As the shelf 5 is between the installed surveying instrument 10 and the operator OP, the operator OP cannot see the surveying instrument 10. Whereas, there is a space between the shelf 5 and the ceiling C, the operator OP can directly see the ceiling C and the main irradiated point Pa and the auxiliary irradiated point Pb projected onto the ceiling C.

As the operator OP can observe the main irradiated point Pa and auxiliary irradiated point Pb irradiated onto the ceiling C, the operator OP can determine the direction in which the surveying instrument is installed by connecting the main irradiated point Pa1 to the auxiliary irradiated point Pb1 and extending the connected imaginary line (see the chain-dotted line CL in FIG. 8). Furthermore, determining the direction in which the surveying instrument 10 is installed allows the Operator to determine the sighting direction of surveying instrument 10.

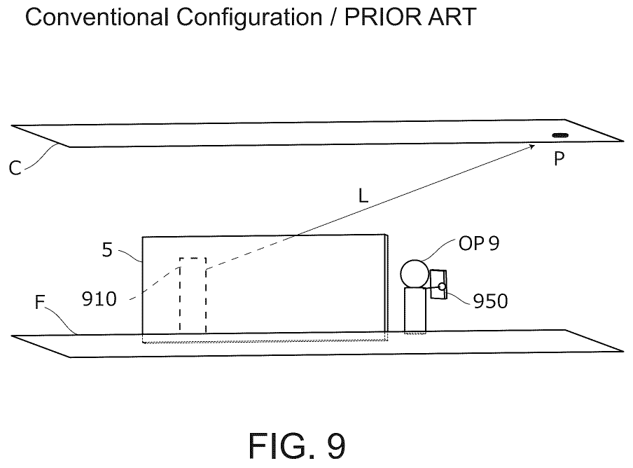

FIG. 9 illustrates a comparative example of surveying utilizing a conventional surveying instrument 910, which is configured to irradiate only a main laser-pointer light L without an auxiliary laser pointer 42, instead of the surveying instrument 10, at the same survey site illustrated in FIGS. 7 and 8.

In the comparative example, as illustrated in FIG. 9, the operator OP can observe only the irradiated point P of the main laser pointer light on the ceiling, whereas the operator OP9 cannot directly see the surveying instrument 910, thereby the operator OP9 cannot know where the surveying instrument is. Consequently, the operator OP9 cannot know whether the surveying instrument 910 is behind or in front of them, making it impossible to determine in which direction, forward, backward, left, or right, to move the telescope of the surveying instrument 910.

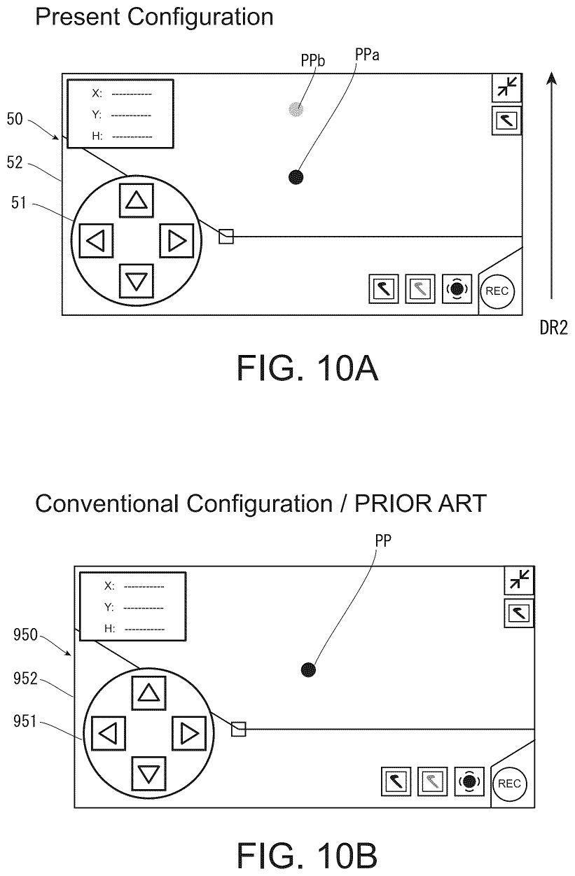

FIGS. 10A and 10B show images displayed on the displays of the operation terminals at the same survey site. FIG. 10A illustrates an image displayed on the display 52 of the operation terminal 50 at the survey site illustrated in FIG. 7. FIG. 10B illustrates an image displayed on the display 952 of the operation terminal 950 of the conventional surveying instrument 910 at the same survey site shown in FIG. 9 for comparison.

In the illustrated example, the operation terminal 50 is implemented using a tablet device with the operation unit 51 integrated into the display 52. The operation terminal 950 has similar configuration.

The imaging unit 30 of the surveying instrument 10 captures images in the sighting direction. So, when the imaging unit 30 is imaging the main irradiated point Pa and auxiliary irradiated point Pb, which are irradiated onto the ceiling C, the display 52 of the operation terminal 50 can display the main irradiated point Pa and auxiliary irradiated point Pb as the main imaged irradiated-point PPa and the imaged auxiliary irradiated-point PPb, respectively (naturally, depending on the field of view of the imaging unit 30, the shape of irradiated object, a irradiated position, etc., either or both irradiated points may not be displayed).

As illustrated in FIG. 10A, the imaged main-irradiated point PPa and the imaged auxiliary-irradiated point PPb can be observed on the screen. While observing the main irradiated point Pa and auxiliary irradiated point Pb directly and through the display 52, the operator OP can send commands to surveying instrument 10 via operation unit 51 to rotate the telescope 18 horizontally and vertically, to move the main irradiated point Pa, i.e., the sighting point, to the desired position. Thus, even when the operator OP cannot see the surveying instrument 10 directly at the site, the operator OP can determine the position of the surveying instrument 10 to drive the horizontal rotation drive unit M1 and vertical rotation drive unit M2 to move the sighting axis of the telescope 18 to the desired position, thereby achieving one-person surveying.

In contrast, as illustrated in FIG. 10B, the conventional surveying instrument 910 only allows the imaged irradiated-point PP to be observed on the display unit. As the operator OP9 can directly observe only the irradiated point P, the operator OP9 cannot know in which direction the surveying instrument 910 is installed and in which direction the operator OP9 should orient the sighting axis to move the sighting axis to the desired position. Consequently, the operator OP9 cannot accurately operate the surveying instrument 910 to move the sighting direction to move the sighting point.

Using the surveying instrument 10 capable of emitting an auxiliary laser pointer light Lb allows the operator OP to determine that the surveying instrument 10 is located in the direction of extension of the line connecting two points of the main irradiated point Pa and the auxiliary irradiated point Pb on the projection surface. Thereby, the operator OP can know the sighting direction when the survey site is viewed from above, that is, in a plan view (hereinafter the sighting direction in a plan view referred to as the horizontal sighting direction). Once the operator OP determines the horizontal sighting direction, it is preferable for the operator OP to align the horizontal sighting direction of the surveying instrument 10 with the direction of the operation terminal 50. This allows the operator OP who is holding the operation terminal 50 for intuitive operation.

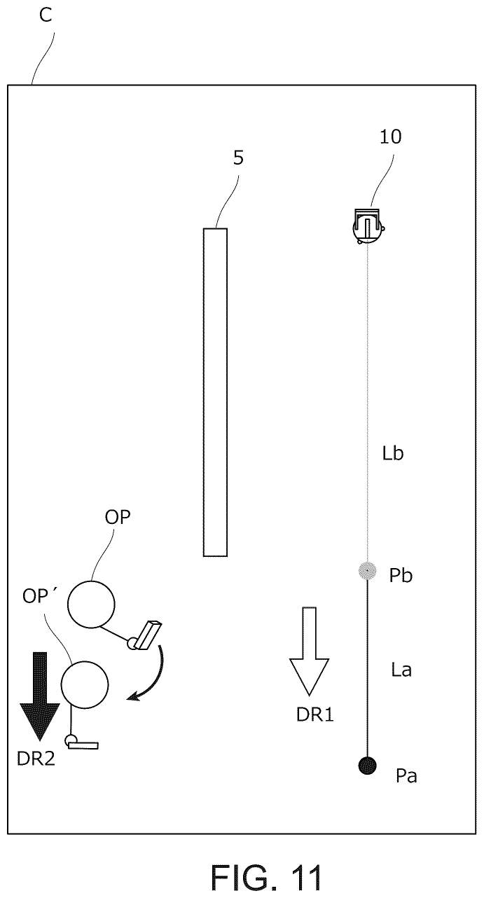

The above operation will be explained further in detail with reference to FIG. 11. FIG. 11 is a plan view of the survey site of FIG. 7. FIG. 11 illustrates the survey site viewed from a position further above the ceiling C. The surveying instrument 10 has the telescope 18 oriented upward, projecting the main laser-pointer light La and the auxiliary laser-pointer light Lb onto the ceiling C. In FIG. 11, the ceiling C is depicted as transparent.

As described above, the operator OP can determine that the surveying instrument 10 is on the extension of the line segment from the main irradiated point Pa to the auxiliary irradiated point Pb. Furthermore, the operator OP can also determine that the direction from the surveying instrument 10 toward the main irradiated point Pa is the sighting direction of the surveying instrument 10 in the horizontal plane (the horizontal sighting direction DR1, indicated by a hollow arrow).

The operator OP determines the horizontal sighting direction DR1 of surveying instrument 10 based on the main irradiated point Pa and auxiliary irradiated point Pb irradiated onto the ceiling C. The operator OP rotates their body holding the operation terminal 50 so that the horizontal sighting direction DR1 aligns with the direction of the operation terminal 50 (see the operator OP′ in the FIG. 11).

Thus, the operator OP aligns the direction of the operation terminal 50 (indicated by black arrow DR2) with the horizontal sighing direction DR1 by rotating his body. This enables the operator OP to smoothly control the sighting direction of the surveying instrument. Aligning the direction DR1 and the direction DR2 in terms of two-dimensional vector directions (vector directions on the plan view) allows the direction of the actual irradiated point P to be viewed directly to match the direction of the imaged irradiated point PP on the screen of the display 52 when the operator OP operates the surveying instrument using the operation terminal 50. Consequently, the operation direction and the movement direction of the irradiated point P coincide, enabling intuitive operation for the operator OP and smooth surveying. The operator OP uses the operation terminal 50 while holding it in his hand and looking at it. The direction DR2 represents the direction in which the operator views the operation terminal 50. In other words, the direction DR2 is the direction that is from the front surface to the back surface of the operation terminal 50. The operator should align the direction DR2 with the horizontal sighting direction DR1 in plan view.

With conventional surveying instruments, the operator can only observe the sighting point. When the operator cannot observe the surveying instrument, he cannot determine the sighting direction of the surveying instrument. When the operator cannot see the surveying instrument, it is difficult to align the sighting point of the surveying instrument to the desired point with remote controlling.

By contrast, the surveying instrument 10 enables the operator to determine the direction in which the surveying instrument 10 is installed and the sighting direction by emitting an auxiliary laser-pointer light Lb. This makes one-person surveying easier. Furthermore, aligning the direction DR2 of the operation terminal 50 with the horizontal sighting direction DR1 allows the operator OP who is holding the operation terminal 50 to accurately control the sighting axis, making surveying work easier.

In particular, the surveying instrument 10 has the cover member 16 covering the telescope 18, making the telescope 18 externally invisible. Consequently, it is impossible to confirm the current direction of the sighting axis based on the orientation of the telescope 18. By emitting the main laser-pointer light La and the auxiliary laser-pointer light Lb, the sighting direction can be determined even when the telescope 18 is invisible.

### Flowchart

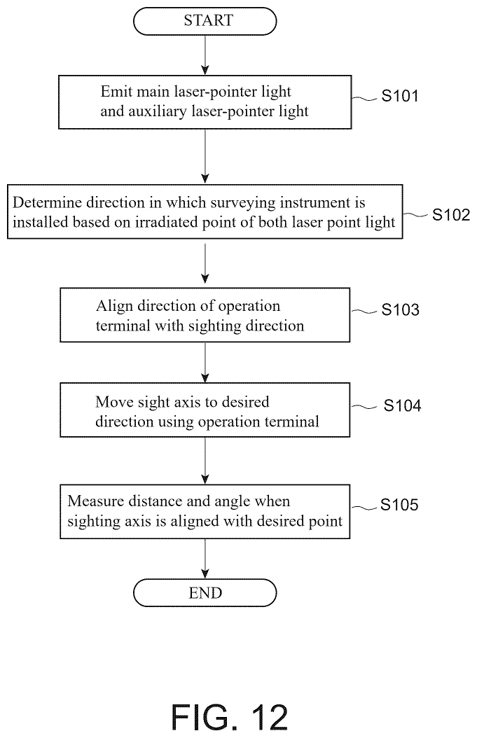

FIG. 12 is a flowchart of the operation to move the irradiated point P to a desired position.

As shown in FIG. 12, first, in step S101, as an irradiation step, the surveying instrument 10 irradiates both the main laser-pointer light La and the auxiliary laser-pointer light Lb.

Next, in step S102, as a determination step, an operator determines the direction in which the surveying instrument 10 is installed and the sighting direction of the surveying instrument 10, based on the main irradiated point Pa of the main laser-pointer light La and the auxiliary irradiated point Pb of the auxiliary laser-pointer light Lb.

Next, in step S103, as an alignment step, the direction DR2 of the operation terminal 50 is aligned with the horizontal sighting direction DR1. The operator OP changes his orientation with holding the operation terminal 50 in front of himself to coincides in the horizontal plane with the sighting direction of the surveying instrument 10, which is determined in step S102.

Next, in step S104, as a sighting step, the operator OP operates the surveying instrument 10 via the operation unit 51 to bring the sighting axis of the surveying instrument 10, causing the surveying instrument 10 to sight the desired position.

Next, in step S105, as a measurement step, the operator OP has the surveying instrument 10 sight the desired point. After confirming that the main irradiated point Pa has moved to the desired point, the operator OP operates the surveying instrument 10 to measure the distance and angle.

The above embodiments are examples of the present disclosure. A person skilled in the art can combine these embodiments based on his knowledge, and the present disclosure also includes such forms.

### REFERENCE SIGNS

10: Surveying instrument
14: Rotary base
15: Surveying-instrument main body
16: Cover member
16a: Window
17a: Support member
18: Telescope
41: Main laser pointer
42: Auxiliary laser pointer
50: Operation terminal
51: Operation unit
DR1: Direction
DR2: Direction
La: Main laser-pointer light
Lb: Auxiliary laser-pointer light
Ls: Distance measuring light
OP: Operator
θ: Angle

1. A surveying instrument configured to:
emit a visible laser beam coaxial with or parallel in a vertical plane to a sighting axis as main laser-pointer light; and
emit a laser beam in a different form from the main laser-pointer light, as auxiliary laser-pointer light at a predetermined angle to the main laser-pointer light in a vertical plane containing the main laser-pointer light.

2. The surveying instrument according to claim 1, comprising:
a surveying instrument body,
a telescope including an optical system provided in the surveying instrument body, and the telescope supported capable of rotating in a horizontal direction and vertical direction,
a main laser pointer supported by the telescope and configured to irradiate the main laser-pointer light in a direction of an optical axis of the telescope, and
an auxiliary laser pointer supported by the telescope and configured to irradiate the auxiliary laser-pointer light.

3. The surveying instrument according to claim 2, comprising:
the surveying instrument body, the telescope, a base portion, a rotary base rotatable with respect to the base portion, a cover member, the main laser pointer, and the auxiliary laser pointer,
wherein the rotary base is provided with a supporting member that supports the telescope rotatably in a vertical direction, and the cover member covers the supporting member and the telescope, and
wherein distance measuring light, the main laser-pointer light and the auxiliary laser-pointer light are transmitted through a window provided with the cover member.

4. The surveying instrument according to claim 1,
wherein the main laser-pointer light is visible distance measuring light.

5. A surveying method using a surveying instrument configured to: emit a visible laser beam coaxial with or parallel in a vertical plane to a sighting axis as main laser-pointer light; and emit a laser beam in a different form from the main laser-pointer light, as auxiliary laser-pointer light at a predetermined angle to the main laser-pointer light La in a vertical plane containing the main laser-pointer light, and an operation terminal including an operation unit configured to operate a sighting direction of the surveying instrument, the method comprising:
an irradiation step of irradiating the main laser-pointer light and the auxiliary laser-pointer light together,
a determination step of determining the sighting direction of the surveying instrument based on an irradiated point of the main laser-pointer light and an irradiated point of the auxiliary laser-pointer light,
an alignment step of aligning a horizontal direction of the operation terminal with the horizontal direction of the sighting direction of the surveying instrument, which determined in the determination step,
a sighting step of moving the sighting direction of the surveying instrument to a desired direction via the operation terminal.

6. The surveying instrument according to claim 2,
wherein the main laser-pointer light is visible distance measuring light.

7. The surveying instrument according to claim 3,
wherein the main laser-pointer light is visible distance measuring light.
